(19) United States
(12) Patent Application Publication
(10) Pub. No.: US 2006/0294191 A1
(43) Pub. Date: Dec. 28, 2006

(54) PROVIDING CONTEXT IN AN ELECTRONIC MESSAGING SYSTEM

(76) Inventors: Justin Marston, Richmond (GB); Amy Flamenbaum, Chicago, IL (US)

Correspondence Address: FENWICK & WEST LLP, SILICON VALLEY CENTER, 801 CALIFORNIA STREET, MOUNTAIN VIEW, CA, 94041, US

(21) Appl. No.: 11/426,118

(22) Filed: Jun. 23, 2006

Related U.S. Application Data
(60) Provisional application No. 60/693,605, filed on Jun. 24, 2005.
(60) Provisional application No. 60/758,828, filed on Jan. 13, 2006.

(51) Int. Cl. G06F 15/16

(52) U.S. Cl. 709/206

(57) ABSTRACT

A messaging system treats a set of related messages, such as an e-mail string between two or more people, as a message container having relational references to one or more submessages. A messaging server stores the messages and submessages as discrete message components having content. In addition, the messaging server includes a context module having a context database. The context module defines a knowledge taxonomy having context categories. The context module creates contexts by associating portions of content from the message components with the context categories. The context module also specifies rights and properties of end-users with respect to the context categories and contexts. The context module performs operations utilizing the contexts. The contexts thus allow an enterprise to structure information contained within its electronic messages.

### CROSS-REFERENCE TO RELATED APPLICATIONS

This application claims the benefit of U.S. Provisional Application Nos. 60/693,605, filed Jun. 24, 2005, and 60/758,828, filed Jan. 13, 2006, both of which are hereby incorporated by reference herein. This application is related to U.S. patent application Ser. No. 10/789,461, filed Feb. 26, 2004, which is hereby incorporated by reference herein.

### BACKGROUND OF THE INVENTION

1. Field of the Invention

This invention pertains in general to electronic messaging and in particular to categorizing and assigning contexts to messages exchanged using an electronic messaging system.

2. Description of the Related Art

Before the introduction of e-mail, business users relied on two forms of communication—the phone and the business letter. The former was momentary and casual, the latter was retained as a business record and was considered formal. E-mail has blurred those two communication requirements into one tool—people use it both formally and casually, but it is retained for an indefinite time period (typically years) depending on how an enterprise's Information Technology (IT) system has been set up.

A problem with current e-mail systems is that messages are just simple text strings. When a user writes a message, it is formed into the first e-mail, but may then go on to be included in many other e-mails during its lifetime. This results in many copies of the same, user-authored, message in different, unrelated, mail “snapshots.” Storing multiple copies of the same messages is inefficient and undesirable. Moreover, the contents and topics discussed in the e-mails change over time, making it difficult to ascertain which e-mails constitute important business records.

Enterprises are now searching for a way to deal with the problem of separating messages that constitute business records from the general “chatter” of e-mail. Such business records must be retained in a manner that reflects the business processes to which the content relates. However, there are few, if any, ways to automate the process of filtering, storing, and retrieving business-related e-mails.

Therefore, there is a need in the art for an electronic messaging system that eases the task of separating business records from general e-mail “chatter” and allows important business records to be retained and retrieved in an effective manner.

### BRIEF SUMMARY OF THE INVENTION

The above need is met by a messaging system that utilizes a knowledge taxonomy having context categories, and supports contexts formed of associations of content to the context categories. In one embodiment, the messaging system treats a set of related messages, such as an e-mail string between two or more people, as a message container having relational references to one or more submessages. A messaging server stores the messages and submessages as discrete message components having content. In addition, the messaging server includes a context module having a context database. The context module defines a knowledge taxonomy having context categories. The context module creates contexts by associating portions of content from the message components with the context categories. The context module also specifies rights and properties of end-users with respect to the context categories and contexts. The context module performs operations utilizing the contexts. The contexts thus allow an enterprise to structure and operate on information contained within its electronic messages.

### BRIEF DESCRIPTION OF THE DRAWINGS

FIG. 1 is a high-level block diagram illustrating a messaging system according to one embodiment.

FIG. 2 is a block diagram illustrating a representation of a message exchanged according to an embodiment of the messaging system.

FIG. 3 illustrates a set of interactions that explain the relationship among messages, current submessages, and history submessages.

FIG. 4 is a high-level block diagram illustrating modules within the messaging server according to one embodiment of the messaging system.

FIG. 5 is a high-level block diagram illustrating modules within the context module according to one embodiment.

FIG. 6 illustrates a knowledge taxonomy according to one embodiment and shows the relationship between context categories and content in a message.

FIG. 7 is a high-level block diagram illustrating modules within the messaging client according to one embodiment of the messaging system.

FIG. 8 illustrates an embodiment of a GUI generated by the UI module to enable an end-user to create a context.

FIG. 9 illustrates an embodiment of a GUI generated by the UI module to enable an end-user to view a context for content in the messaging system.

FIG. 10 illustrates an embodiment of a GUI generated by the UI module to enable an end-user to browse the knowledge taxonomy and view contexts at various nodes in the taxonomy.

FIG. 11 is a flow chart illustrating steps performed when using the messaging system to create and operate on a context according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

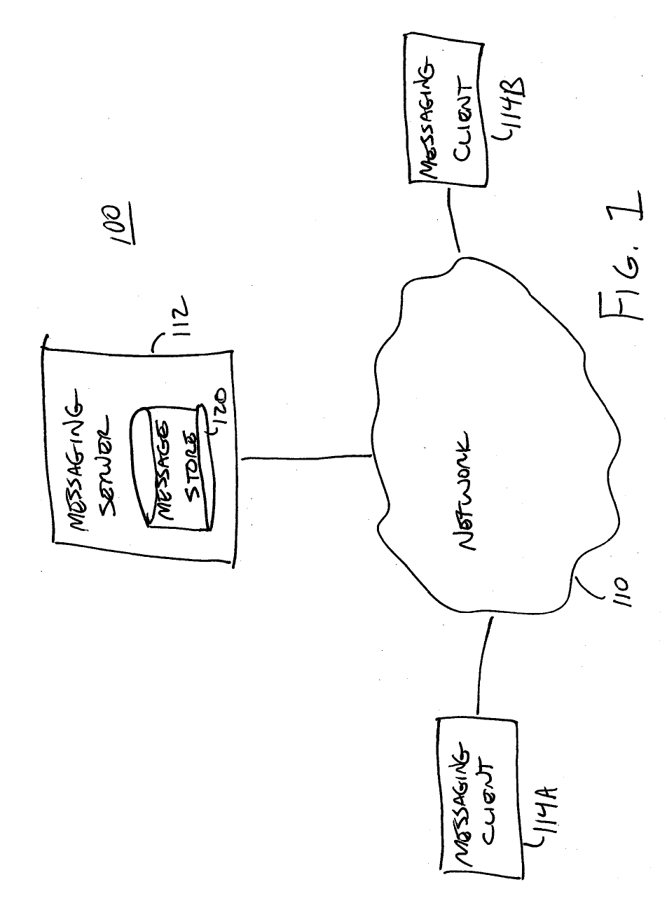

FIG. 1 is a high-level block diagram illustrating a messaging system 100 according to one embodiment. In one embodiment, the messaging system 100 is utilized by an enterprise such as a corporation or governmental entity to provide messaging among end-users associated with the enterprise. Therefore, much of this discussion assumes that the messaging system is being used by a single enterprise. In other embodiments, the messaging system 100 is utilized by end-users not necessarily associated with a common enterprise.

The messaging system 100 of FIG. 1 includes a messaging server 112 and multiple messaging clients 114. A network 110 couples the server 112 and clients 114. End-users of the messaging clients 114 use the messaging system 100 to send messages to other end-users. The end-users can create contexts that associate message content with categories of a knowledge taxonomy, and can perform searches and other operations based on the contexts. Thus, using contexts provides a way to organize, search, and retrieve knowledge represented within the messages.

FIG. 1 and the other figures use like reference numerals to identify like elements. A letter after a reference numeral, such as “114A,” indicates that the text refers specifically to the element having that particular reference numeral. A reference numeral in the text without a following letter, such as “114,” refers to any or all of the elements in the figures bearing that reference numeral (e.g. “114” in the text refers to reference numerals “114A” or “114B” in the figures).

In the embodiment of FIG. 1, the messaging system 100 shares characteristics with the system described in U.S. patent application Ser. No. 10/789,461, which is incorporated by reference herein. As described in that application, the messaging system uses a relational model to represent and store messages exchanged among the end-users.

As used herein, the term “message” refers to a data communication sent by one end-user to one or more end-users of the messaging system or another messaging system. In one embodiment, described below, a message is a container having relational references to content, context data, audit data, and/or other types of data. In other embodiments, the messages are emails, Short Message Service (SMS) messages, Instant Messages (IMs), Multi-Media Message (MMS) and/or other types of messages. The term “message” can also include media files, such as discrete and/or streaming audio and/or video, still images, etc. and files created by other applications. An end-user can perform various actions on messages, including composing, sending, reading, replying to, and forwarding. In addition, an end-user can assign a context to all or a portion of a message.

The network 110 enables data communication between and among the entities connected to the network and allows the entities to exchange messages. In one embodiment, the network 110 is the Internet. In another embodiment, the network 110 is an enterprise network.

In one embodiment, the network 110 uses standard communications technologies and/or protocols. Thus, the network 110 can include links using technologies such as Ethernet, 802.11, integrated services digital network (ISDN), digital subscriber line (DSL), asynchronous transfer mode (ATM), etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 110 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

In one embodiment, the messaging server 112 is a computer system acting as a central repository for messages received by the end-users of the messaging system 100. The messaging server 112 communicates with the messaging clients 114 via the network 110. In some embodiments, the messaging server 112 also communicates with messaging servers and clients of other messaging systems via the network 110. The messaging server 112 provides interfaces that allow other entities in the messaging system 100, such as the messaging clients 114, to exchange messages with each other.

The messaging server 112 includes a message store database 120 that stores information about messages exchanged using the messaging system, or at least a designated subset of the messages exchanged using the system. In one embodiment, the stored information includes the content of the message and any audit, context, governance policy, and/or other information that are associated with the message. As used herein, the term “database” refers to an information store and does not imply that the data within the database are organized in a particular structure beyond that described herein.

Although only a single database 120 is illustrated in FIG. 1, embodiments of the messaging server 112 can utilize multiple databases. In addition, the database 120 can be local or remote to the messaging server 112. In FIG. 1, the database 120 is illustrated as being local to the messaging server 112 for purposes of clarity.

The messaging client 114 is a device utilized by an end-user to compose, send, and view messages. In addition, the end-user uses the messaging client 114 to associate contexts with content within messages, and to perform operations based on the associated contexts. The contexts are used by individual end-users to help structure their own message content, and are also used collaboratively among end-users to assist in knowledge sharing, storage, and retrieval for the enterprise.

The messaging client 114 is connected to the network 110 and can communicate with the messaging server 112 and/or other entities coupled to the network. In one embodiment, the messaging client 114 is a personal computer. In other embodiments, clients 114 is another type of electronic device, such as a personal digital assistant (PDA), a cellular telephone with text messaging functionality, a portable email device, etc.

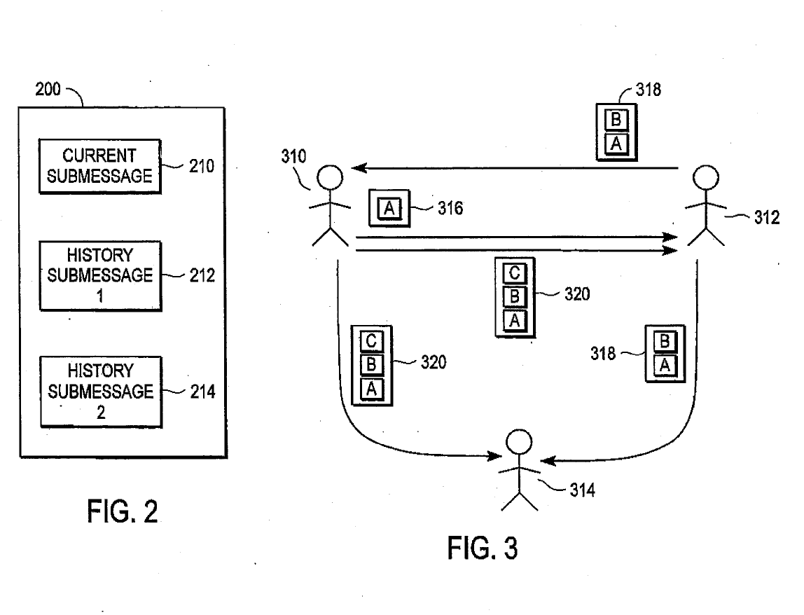

FIG. 2 is a block diagram illustrating a representation of a message 200 exchanged according to an embodiment of the messaging system 100. A message 200 can be thought of as a container with relational references. The container itself does not contain content, but rather points to submessages and/or attachments in which content resides. In addition, the container can point to other information about the message 200, such as audit, contest, and governance policy information. A message 200 can also be conceptualized as a document having multiple paragraphs, where each paragraph can be individually identified and isolated. Multiple people can contribute paragraphs to the document, and the document itself can be formed of references to paragraphs written by the different authors. In one embodiment, the message container is extensible, and can point to other types of data such as patient codes, embedded graphics, and questionnaires. This description uses the term “message components” to refer to the message, submessages, and attachments.

When an end-user composes and sends a message, she is actually composing content for a submessage, and then sending a message 200 containing a reference to the submessage to other end-users. The submessage composed and sent by the end-user is called the “current submessage” 210. Any submessages that were previously in the message 200 are called “history submessages” 212, 214. For example, if an end-user receives a message 200 containing one submessage, at the time of receipt the single submessage is the current submessage. When the end-user composes and sends a reply, the submessage containing the reply becomes the current submessage, and the other submessage becomes a history submessage.

The end-user can also associate one or more attachments with a submessage. In one embodiment, the attachments are relationally-referenced within a message in the same manner as submessages. Thus, attachments can be treated in the same manner as submessages and descriptions of submessages contained herein are equally applicable to attachments. The exemplary message 200 of FIG. 2 contains one current submessage 210 and two history submessages 212, 214 representing previously sent submessages within the message 200.

FIG. 3 illustrates a set of interactions that explain the relationship among messages 200, current submessages 210, and history submessages 212, 214. The figure illustrates three people, Alice 310, John 312, and Peter 314. Initially, Alice 310 composes a message 316 containing submessage A and sends it to John 312. John 312 replies 318 and also copies the message to Peter 314. In the reply 318, submessage B is the current submessage and submessage A becomes a history submessage. Next, Alice 310 replies to both John 312 and Peter 314 and sends a third version 320 of the message having a new current submessage C, and two history submessages A and B.

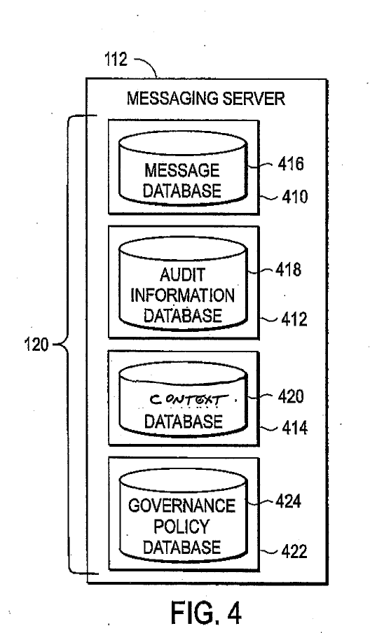

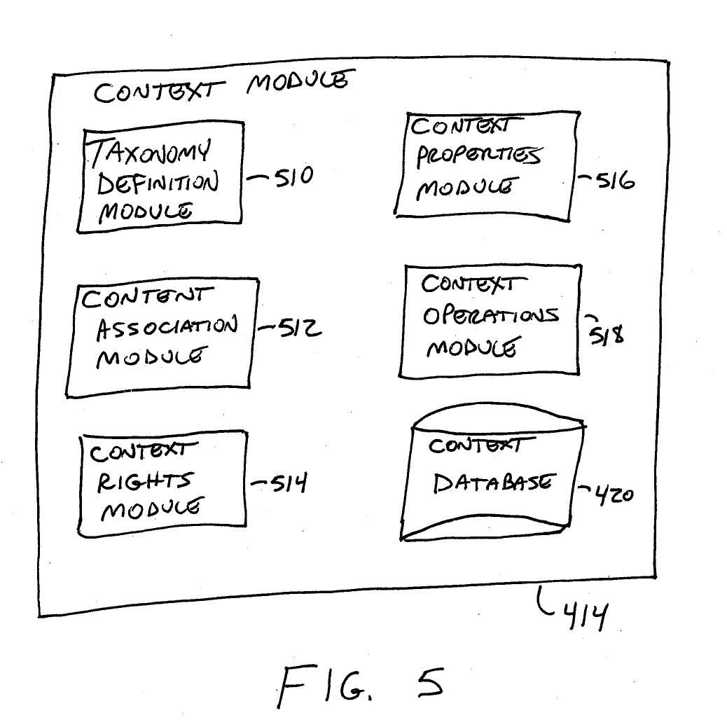

FIG. 4 is a high-level block diagram illustrating modules within the messaging server 112 according to one embodiment of the messaging system 100. In the illustrated embodiment, the messaging server 112 includes a message module 410, an audit module 412, a context module 414, and a governance module 422. These modules respectively contain a message database 416, an audit information database 418, a context database 420, and a governance policy database 424. In one embodiment, these databases collectively form the message store database 120 shown in FIG. 1.

Although separate modules and databases are illustrated in FIG. 4, in some embodiments these elements are combined and/or distributed in different manners than shown. Other embodiments contain additional and/or different databases and modules than the ones shown in FIG. 4. As used herein, the term “module” refers to computer program logic and/or data for providing the specified functionality. A module can be implemented in hardware, firmware, and/or software.

The message module 410 controls the message database 416. This database 416 stores messages, submessages, attachments, and other related data. These data are stored as logically discrete components, meaning that each message component can be accessed separately. In one embodiment, the message database 416 associates a unique ID with each message component. These IDs are utilized throughout the messaging system to refer to the components.

The audit module 412 generates audit information and interacts with the audit information database 418. The audit information describes the usage of the messaging system 100. Audit information thus indicates which end-users composed which submessages, which users read which submessages, which users replied to and/or forwarded which submessages, etc. The audit information can also describe characteristics of the message components such as sensitivity levels for particular submessages, whether the messages can be viewed by an end-user when the end-user's messaging client 114 is offline, etc.

The context module 414 supports activities in the messaging system 100 involving contexts and controls the context database 420. In one embodiment, the context module 414 provides a structured taxonomy of knowledge to which end-users can associate content, such as message components and portions of components. Each classification in the taxonomy is called a “context category.” An association of a context category to content is termed a “context” of the content. The context module 414 supports operations on the content based on the associated contexts. For example, the context module 414 supports a search to identify all content having a particular context. In one embodiment, a context is a type of message component.

The governance module 422 (also called a “compliance module”) applies governance policies (also called “compliance policies”) to the messaging system 100 and controls the governance policy database 424. The database 424 stores compliance policies that are established on the messaging system 100. A compliance policy describes the set of rules that apply to message components during their lifecycles in the messaging system. In one embodiment, each message component in the messaging system is associated with one or more compliance policies. When an action occurs that involves a message component, the messaging system identifies the relevant compliance policy in the governance policy database 424 and applies it.

FIG. 5 is a high-level block diagram illustrating modules within the context module 414 according to one embodiment. Other embodiments have additional and/or different modules than the ones shown in FIG. 5. In addition, in other embodiments the functionalities are distributed among the modules in a different manner. In one embodiment, administrators, end-users, and/or other people associated with the enterprise uses messaging clients 114 to interact with the context module 414 and access the functionality provided by its various modules.

A taxonomy definition module 510 defines and maintains one or more knowledge taxonomies utilized by the enterprise. A knowledge taxonomy categorizes the knowledge possessed and/or activities performed by the enterprise, by an end-user, and/or by another entity. In one embodiment, a knowledge taxonomy is hierarchical. The taxonomy is represented as an inverted tree, in which each node and leaf is a context category. Context categories can thus have parent context categories (the context category above them in the hierarchy) and context subcategories (any context categories below them in the hierarchy). In one embodiment, properties assigned to context categories in the knowledge tree are inheritable. Thus, nodes of the tree inherit properties from their parent nodes. In other embodiments, the knowledge taxonomy is described by a non-hierarchical representation and lacks inheritable properties.

An end-user uses a messaging client 114 to interact with the taxonomy definition module 510 and define and/or access a knowledge taxonomy. In one embodiment, an enterprise-wide knowledge taxonomy is utilized by all end-users of the messaging system 100 to structure content. The enterprise-wide knowledge taxonomy is defined by an administrator or other person with the appropriate authority. In some embodiments, end-users also create personal taxonomies that enable them to structure their own content. If desired, an end-user can inherit a node from an enterprise taxonomy or another existing knowledge taxonomy and then define personal context categories beneath that node. In addition, some embodiments have knowledge taxonomies that are shared by a subset of the end-users in the enterprise.

In one embodiment, the taxonomy definition module 510 interfaces with an external data source in order to receive and/or create a knowledge taxonomy. For example, the taxonomy definition module 510 can receive a taxonomy from an external knowledge management tool. Similarly, the taxonomy definition module 510 can interface with an external directory, such as a lightweight directory access protocol-(LDAP) or Active Directory-based directory, to identify the taxonomic structure.

A content association module 512 associates content with the context categories defined by the taxonomy definition module 512. In one embodiment, an end-user instructs the content association module 512 to associate content with a category. An end-user can associate content with context categories at varying granularities. For example, entire messages and message components can be associated with a context category. In addition, portions of message components, such as a few words or sentences within a submessage, can be associated with a context category. Moreover, the same content can be associated with multiple context categories.

In one embodiment, the content association module 512 allows an end-user to associate context categories with content external to the messaging system 100. For example, the content association module 512 can associate a file or portion of a file on an end-user's local client 114 with a context category. The end-user can thus assign content in files such as MICROSOFT WORD documents, EXCEL spreadsheets, and/or POWERPOINT presentations to a context category. Further, in one embodiment the content association module 512 allows an end-user to associate different versions of the same file with context categories. This assignment is accomplished, for example, by interfacing with a document management system that tracks the file creation and editing process. In one embodiment, the content association module 512 allows an end-user to associate context categories with content on the Internet or another network. For example, the end-user can associate a context category with a portion of a blog written by the end-user or another person and posted on a publicly-accessible web server. In one embodiment, the content association module 512 copies external content having a context into the context database 420 and/or to another data store. In another embodiment, the content association module 512 stores a pointer to the external content instead of the content itself.

In one embodiment, the content association module 512 monitors content passing through the messaging system 100 and automatically creates contexts by associating content with context categories. An embodiment of the content association module 512 uses keyword searching to identify portions of submessages having specified characteristics and associates the portions with context categories according to rules provided by an end-user.

In one embodiment, the content association module 512 interfaces with an external module that performs automated filtering and/or indexing of message system content (and/or external content) and generates contest suggestions. The external module provides the context suggestions to the content association module 512. The content association module 512 can create the contexts suggested by the external module or store the suggestions for further review. An end-user evaluates the suggested contexts and either validates or rejects the suggestions. In one embodiment, suggested contexts are distinguished from other contexts through the use of patterns, colors, and/or other user interface (UI) elements when displayed to an end-user.

A context rights module 514 controls administration and/or access rights associated with contexts and context categories. In one embodiment, the contexts rights module 514 associates context rights to end-users of the messaging system 100. Each right has one or more associated actions that end-users having the right are allowed to perform. In one embodiment, end-users are organized into groups and the administrative and/or access rights are granted on a per-group basis.

In one embodiment, the administrative rights that the context rights module 514 supports include the right to change a context category's properties, right to control which end-users can add contexts to the context category, and/or right to control which end-users can view the context category. In addition, the rights include the right to create context categories underneath a context category in the knowledge taxonomy. Administrative rights are not “all or nothing” rights. Thus, each allowable action represented by a right can be individually granted to an end-user. For example, end-users can be granted rights allowing creation of new context categories beneath an existing context category, but not allowed to change the viewing rights associated with the context categories.

In one embodiment, the access rights that the context rights module 514 can associate with an end-user include usage rights and viewing rights. An end-user having usage rights for a given context category can associate content with the context category by creating a context. In addition, an end-user having usage rights can edit associations of content to context categories, and delete previously-made associations. Again, these usage rights are comprised of a set of allowable actions, and the allowable actions can be individually granted to an end-user.

In one embodiment, the allowable actions associated with usage rights specify which content the end-user can use. An action can allow an end-user to create a context for content the end-user creates, to create a context for content the end-user receives, to utilize context content in a message, and/or to create a context for content created or received by other end-users. In addition, the usage rights and allowable actions can have limitations such as times of day that they are applicable, the maximum permissible size of content that can be associated with a context category, etc.

An end-user having viewing rights for a given context category can view the category and content associated with that category. The viewing rights have a set of allowable actions, including viewing a context category, viewing given content linked to a context category only when the end-user has received the content directly as part of a message, and/or viewing content associated with a context by browsing the knowledge taxonomy, without having needed to receive the content in a message. An end-user can have different viewing rights for different context categories.

Having viewing rights to a context category is different than having viewing rights to the content associated with it through contexts. For example, a junior Human Resources (HR) clerk can have viewing rights to all HR contexts. However, a governance policy enforced by the governance module 422 can specify that the junior HR clerk cannot view certain content, even though the content has an HR context. Thus, the governance policy rights can supersede the context viewing rights in one embodiment.

A context properties module 516 controls and maintains properties associated with the context categories and/or contexts. In one embodiment, the properties include a validity period and a retention period. The validity period of a context category defines the period of time during which content can be associated with it. Once the validity period of a context category expires, the category can still be accessed and operated upon in the normal manner, except that end-users are prohibited from creating new associations of content with the context category.

The retention period of a context defines the period of time during which the context category is retained by the messaging system 100. The retention period, in essence, specifies the period of time during which an association between content and a particular context category is maintained by the contexts module 414. In one embodiment, the retention period of a context does not control the retention period for the content itself, retention periods for content are controlled by governance policies (though contexts may be used as input to the governance policies). When given content is deleted according to a governance policy, any contexts associated with the content are also deleted. When all associations to content for a context category have been deleted, either through the retention period for the content or the content's contexts expiring, then the content category itself is eligible for deletion. The retention period for the context category controls if and when the context category is deleted. In one embodiment, a context category of the knowledge taxonomy inherits its validity and/or retention periods from its parent nodes. An administrator can change the child category's validity/retention to a time period that is a subset of the time periods of the parent nodes.

In one embodiment, the context properties module 516 maintains additional properties for contexts. One such property is a comment. An end-user can associate a comment with a context category and/or context. In one embodiment, the comment is a text string, though in other embodiments a comment can include audio, video, and/or multimedia data. The end-user can use the comment to explain the reason for the context, discuss attributes of the content being associated with a context category, and/or describe other pertinent information. In one embodiment, the ability to view comments is an allowable action that can be permitted as an access right. In addition, in one embodiment a comment is subject to the same validity and retention periods as its associated context and/or context category. Other properties maintained by the context properties module 516 include the identity of the end-user that created the context, and timestamps of events involved in the context creation.

In one embodiment, the context properties module 516 assigns validity periods, retention periods, an/or other proprieties to context categories in the knowledge taxonomy. Thus, the context categories and contexts can inherit their properties from parent categories in the taxonomy. In another embodiment, the properties are not inheritable and rather are assigned to individual context categories in the knowledge taxonomy.

In one embodiment, an operations module 518 supports and performs operations based on contexts. These operations include, for example, requests to navigate the knowledge taxonomy, to associate content with a context category, to search the content based on context, to filter content based on context and/or other criteria, and to sort the content based on context. An additional operation is exporting content from contexts to other systems, such as to a concurrent versioning system (CVS) supporting software development. In one embodiment, the operations module 518 receives requests from other modules in the messaging server 112 and/or messaging clients 114 to perform operations based on context, performs the requested operations utilizing the information in the contexts database 420 , message database 416, and/or other databases, and returns any requested results to the requesters.

The contexts database 420 stores information utilized in the operation of the contexts module 414. The information stored in the database 420 includes, for example, knowledge taxonomies utilized by the enterprise and/or individual end-users and contexts (i.e., associations of content to content categories). In addition, the context database 420 stores data describing the context rights controlled by the context rights module 514 and data describing context properties utilized by the context properties module 516. In certain embodiments, some or all of the information is stored elsewhere in the message store database 120.

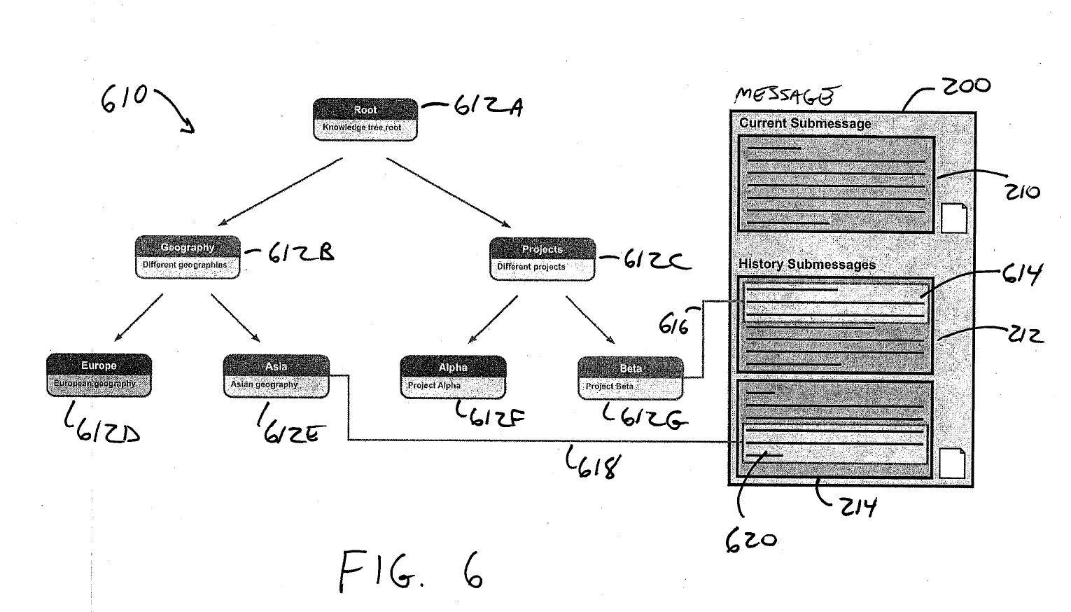

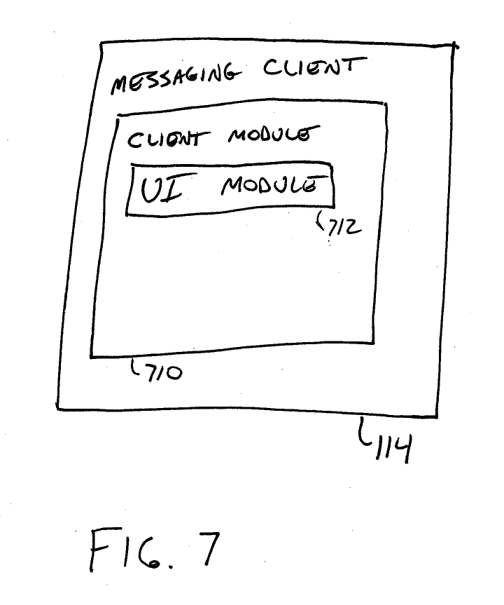

FIG. 6 illustrates a sample knowledge taxonomy 610 according to one embodiment and shows the relationship between context categories and content in a message 200. In this sample, the knowledge taxonomy 610 is a hierarchical tree having seven nodes, or context categories, labeled 612A-612G. Each node 612 has a name (e.g., “Projects”) and a short description of the knowledge represented by the node (e.g., “Different projects”).

The illustrated knowledge taxonomy 610 includes two nodes 612B, 612C immediately below the root node 612A. One of the nodes 612B is named “Geography” and represents the different geographic areas with which content can be associated. The Geography node 612B has two nodes below it in the hierarchy, one node 612D named “Europe” and another node 612E named “Asia.”

The other node 612C immediately below the root node 612A is named “Projects” and represents different projects with which content can be associated. The Projects node 612C has two nodes below it in the hierarchy, one node 612F named “Alpha” and another node 612G named “Beta.”

The message 200 illustrated in FIG. 6 has a current submessage 210 and two history submessages 212, 214. A portion 616 of the first history submessage 212 is associated with the Beta node 612G of the knowledge taxonomy. This association is represented by a line 614 between the portion of the submessage 212 and the node 612G. Similarly, a second line 618 represents an association between a portion 620 of the second history submessage 214 and the Asia node 612E. These associations are the contexts for the content in the portions 614, 620 of the submessages 212, 214.

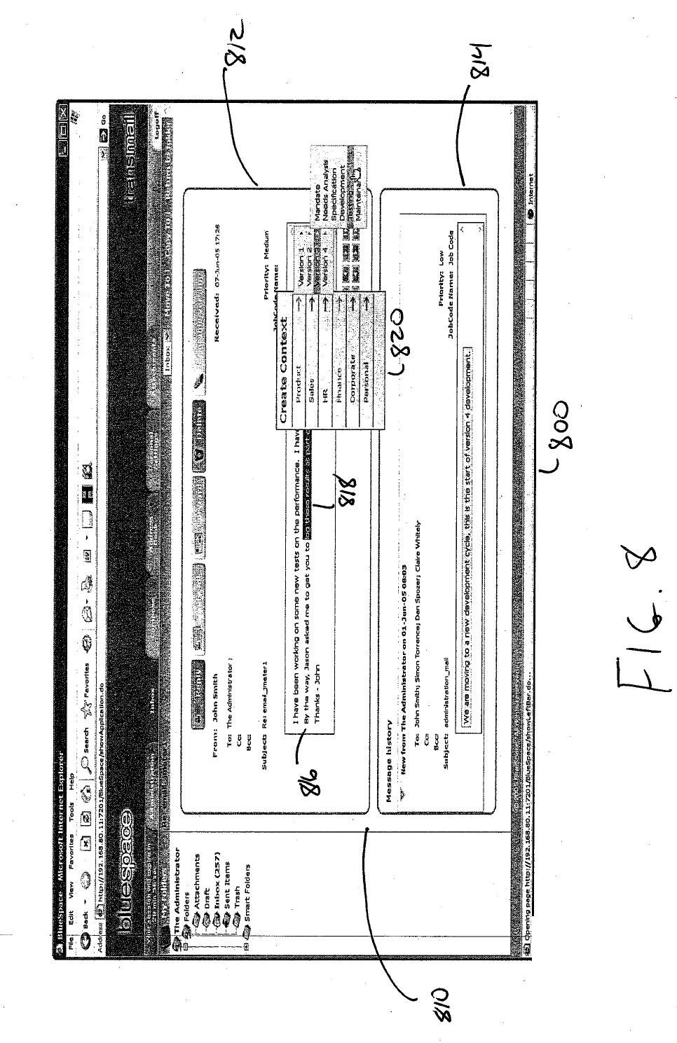

FIG. 7 is a high-level block diagram illustrating modules within the messaging client 114 according to one embodiment of the messaging system. Other embodiments have additional and/or different modules than the ones shown in FIG. 7. Moreover, the functionalities can be distributed among the modules in a different manner.

The messaging client 114 includes a client module 710 adapted to interact with the messaging system. In one embodiment, the client module 710 is an application dedicated to sending and receiving messages via the messaging system. As such, it includes standard functionality for composing messages, viewing messages, replying to and forwarding messages, etc. In another embodiment, the client module 710 operates in tandem with another module, such as a web browser or email application to provide integrated messaging functionality. For example, the client module 710 can comprise a plug-in or other functionality added to a web browser such as MICROSOFT INTERNET EXPLORER or MOZILLA FIREFOX, or to a messaging application such as MICROSOFT OUTLOOK. In one embodiment, the client module 710 is a web browser and utilizes program code and/or data downloaded from the messaging server 112 and/or another server on the network 110 to provide the functionality described herein.

In one embodiment, the client module 710 includes a UI module 712 that provides graphical user interfaces (GUI) allowing the end-user to perform tasks such as composing and sending messages, creating contexts, and reviewing existing contexts. In one embodiment, the GUI allows the end-user to communicate with the context operations module 518 in the contexts module 414 to perform and view the results of operations performed by the module.

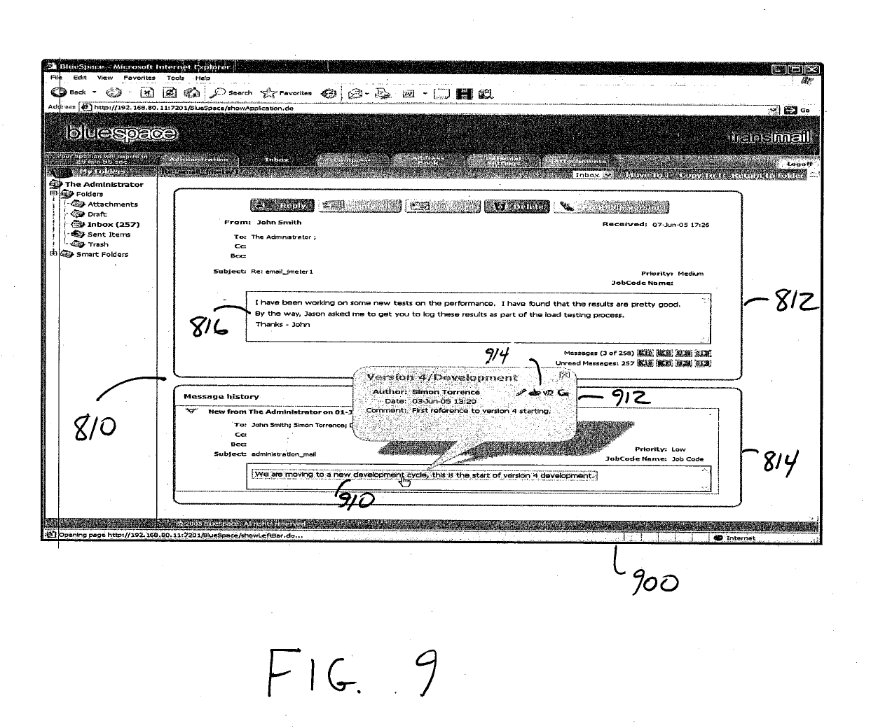

FIG. 8 illustrates an embodiment of a GUI 800 generated by the UI module 712 to enable an end-user to create a context. The GUI 800 displays a message 810 having a current submessage 812 and a history submessage 814. The current submessage 812 includes text 816. In this GUI, the end-user interacts with the messaging client 114 to highlight a portion 818 of the text. In addition, the end-user expresses a desire to create a context for the highlighted portion 818 by, for example, right-clicking using a mouse. In response, the GUI 800 shows a popup menu 820 that allows the end-user to select the context category to associate with the highlighted portion 818 of the text. In this example, the end-user selects the context category “Product→Version 3→Testing.”

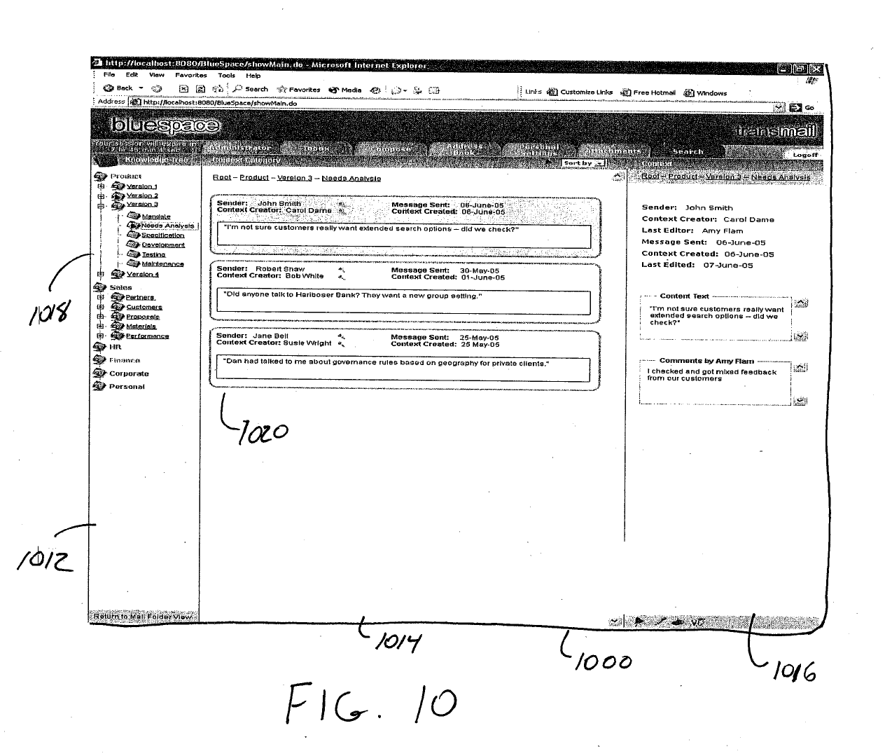

FIG. 9 illustrates an embodiment of a GUI 900 generated by the UI module 712 to enable an end-user to view a context for content in the messaging system. The GUI 900 displays the same message 810 and submessages 812, 814 shown in FIG. 8. In FIG. 9, the end-user selects text 910 in the history submessage 814 by, for example, hovering a cursor over the text. In response to the selection, the GUI 900 displays a popup window 912 displaying the context for the text. In this example, the popup window 912 includes the name of the context category (“Version 4/Development”), the date that the context was created, the author of the context, and a comment that the author supplied for the context.

In addition, the popup window includes icons 914 for performing actions involving the context. In one embodiment, the icons 914 allow the end-user to edit the context, display the history of end-users that edited the context and their respective comments, obtain visualizations of the context and its interaction with the knowledge taxonomy, and view the knowledge taxonomy. The end-user might lack rights to perform some of these actions.

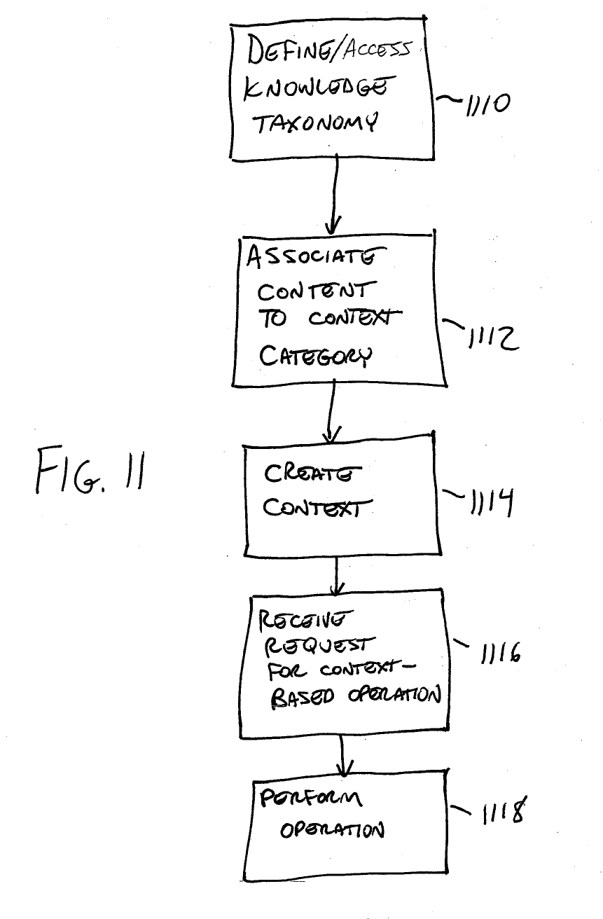

FIG. 10 illustrates an embodiment of a GUI 1000 generated by the UI module 712 to enable an end-user to browse the knowledge taxonomy and view contexts at various nodes in the taxonomy. The GUI 1000 includes three columns 1012, 1014, 1016. In this embodiment, the leftmost column 1012 displays the knowledge taxonomy 1018. The knowledge taxonomy 1018 itself is displayed using a folder view that allows the end-user to expand and collapse views of the hierarchy.

In FIG. 10, the end-user selects the “Product→Version 3→Needs Analysis” context category. Accordingly, the center column 1014 of the GUI 1000 displays the contexts 1020 associated with this category. In this example, there are three contexts 1020. For each context, the GUI 1000 displays information including the content having the context, the sender of the message incorporating the context, the date that the message was sent, the name of the end-user that created the context, and the date that the context was created. Thus, the center column 1014 acts as virtual folder that displays all content in the messaging system 100 associated with the selected context category.

The rightmost column 1016 of the GUI 1000 shows additional details about a context selected by the end-user. In FIG. 10, the end-user selects the first context in the center column 1014. The rightmost column 1016 displays information about this context including the sender of the message incorporating the context, the name of the end-user that created the context, the name of the last editor of the context, the date that the message was sent, the date that the context was created, and the date that the context was last edited. In addition, the rightmost column 1016 displays the content having the context, and any comments on the context added by end-users.

FIG. 11 is a flow chart illustrating steps performed when using the messaging system 100 to create and operate on a context according to one embodiment. Other embodiments include different and/or additional steps. Moreover, other embodiments perform the steps in different orders.

Initially, a knowledge taxonomy is defined and/or an existing taxonomy is accessed 1110. In one embodiment, the knowledge taxonomy is defined by an administrator and is applicable for all content and/or end-users associated with the messaging system 100. End-users can also create personal knowledge taxonomies utilized by only the individual end-users. In one embodiment, the knowledge taxonomy has hierarchical context categories arranged in a tree structure.

During the operation of the messaging system 100, an end-user and/or automated process associates 1112 content with one or more context categories in the knowledge taxonomy. In one embodiment, an end-user creates the association by designating content and selecting a context category. For example, an end-user using the messaging system 100 recognizes that a piece of content in a message is related to a context category to which the end-user has access. The end-user highlights the text or other content, right-clicks on the content to spawn a popup menu, and uses the menu to navigate the knowledge taxonomy and select the appropriate context category. In addition, the end-user optionally provides a comment to associate with the context. Further, the end-user can supply additional information about the context, such as information specifying potential viewers and editors of the context (if the end-user has rights to do so).

The messaging system 100 creates 1114 the context associating the content and the context category. Since an embodiment of the messaging system 100 is relational, the context is reflected across the entire messaging system. Thus, any end-user that views the content can access the associated context (assuming that the end-user has the appropriate rights).

In one embodiment, the messaging system 100 highlights the designated content to indicate that it has an associated context. The color of the highlighting corresponds to a color scheme assigned to different context categories, so that the context of the content is visually apparent. The end-user can view 1118 the context for content by hovering the cursor over the highlighted content and/or performing a similar action.

An end-user and/or other entity uses a messaging client 114 to generate requests to perform a context-based operations. For example, the end-user can use the client 114 to browse the context categories and thereby generate search queries to identify all of the contexts associated with the categories. The messaging system 100 receives 116 the requests and performs 1118 the requested operations.

In sum, the relational messaging system 100 assists end-users in navigating content they send and receive, as well as external content, by allowing them to structure the content into knowledge taxonomies. End-users can create contexts for personal use and/or for collaboration across an enterprise. Moreover, operations such as searching can be performed based on the contexts.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A computerized messaging server in an electronic messaging system, comprising:
a message module adapted to control a message database storing messages exchanged in the messaging system, each message comprising one or more message components having content; and
a context module adapted to control a context database storing a knowledge taxonomy having context categories and contexts associating content of the message components with the context categories.

2. The messaging server of claim 1, wherein the messaging server is utilized by an enterprise and wherein the context module comprises:
a taxonomy definition module for defining the knowledge taxonomy, the taxonomy structured as a hierarchical tree having nodes for context categories representing knowledge possessed and/or activities performed by the enterprise.

3. The messaging server of claim 1, wherein external content resides at a location external to the messaging server and wherein the context module comprises:
a content association module for creating contexts associating at least a portion of the external content with a context category of the knowledge taxonomy.

4. The messaging server of claim 1, wherein the context module comprises:
a content association module for monitoring messages exchanged by the messaging system and automatically creating contexts associating content of the messages with context categories.

5. The messaging server of claim 1, wherein the messaging system is utilized by end-users and wherein the context module comprises:
a context rights module for specifying actions an end-user is allowed to perform with respect to a context and/or context category.

6. The messaging server of claim 1, wherein the context module comprises:
a context properties module specifying a validity period for a context category, the validity period defining a period of time during which new associations of content to the context category can be made.

7. The messaging server of claim 1, wherein the context module comprises:
a context properties module specifying a retention period for a context category, the retention period specifying a period of time during which an association between content and the context category is maintained by the contexts module.

8. The messaging server of claim 1, wherein the context module comprises:
a context operations module for performing operations in the messaging system utilizing the contexts.

9. A computer program product having a computer-readable medium having computer program instructions tangibly embodied therein for providing an electronic message system, comprising:
a messaging module adapted to control a message database storing messages exchanged in the messaging system, each message comprising one or more message components having content; and
a context module adapted to control a context database storing a knowledge taxonomy having context categories and contexts associating content of the message components with the context categories.

10. The computer program product of claim 9, wherein the messaging server is utilized by an enterprise and wherein the context module comprises:
a taxonomy definition module for defining the knowledge taxonomy, the taxonomy structured as a hierarchical tree having nodes for context categories representing knowledge possessed and/or activities performed by the enterprise.

11. The computer program product of claim 9, wherein external content resides at a location external to the messaging server and wherein the context module comprises:
a content association module for creating contexts associating at least a portion of the external content with a context category of the knowledge taxonomy.

12. The computer program product of claim 9, wherein the context module comprises:
a content association module for monitoring messages exchanged by the messaging system and automatically creating contexts associating content of the messages with context categories.

13. The computer program product of claim 9, wherein the messaging system is utilized by end-users and wherein the context module comprises:
a context rights module for specifying actions an end-user is allowed to perform with respect to a context and/or context category.

14. The computer program product of claim 9, wherein the context module comprises:
a context properties module specifying a validity period for a context category, the validity period defining a period of time during which new associations of content to the context category can be made.

15. The computer program product of claim 9, wherein the context module comprises:
a context properties module specifying a retention period for a context category, the retention period specifying a period of time during which an association between content and the context category is maintained by the context module.

16. The computer program product of claim 9, wherein the context module comprises:
a context operations module for performing operations in the messaging system utilizing the contexts.

17. A method of utilizing contexts in an electronic messaging system, the messaging system exchanging messages comprising one or more message components having content, the method comprising:
defining a knowledge taxonomy having context categories;
associating content of the message components with context categories of the knowledge taxonomy to create contexts; and
searching and/or sorting the content responsive to the contexts.

18. The method of claim 17, wherein the messaging system is utilized by an enterprise and wherein the knowledge taxonomy is structured as a hierarchical tree having nodes for context categories representing knowledge possessed and/or activities performed by the enterprise.

19. The method of claim 17, wherein associating portions of content comprises:
monitoring messages exchanged by the messaging system and automatically creating contexts associating content of the messages with context categories.

20. The method of claim 17, wherein the messaging system is utilized by end-users and further comprising:
specifying actions an end-user is allowed to perform with respect to a context and/or context category.

21. The method of claim 17, further comprising:
specifying a validity period for a context category, the validity period defining a period of time during which new associations of content to the context category can be made.

22. The method of claim 17, further comprising:
specifying a retention period for a context category, the retention period specifying a period of time during which an association between content and a context category is maintained by the contexts module.

23. The method of claim 17, wherein the messaging system is utilized by an end-user and further comprising:
providing a graphical user interface (GUI) to the end-user, the GUI enabling the end-user to create a context associating content of a message component with a context category, and/or view contexts associated with the context category.
